(19) United States
(12) Patent Application Publication
(10) Pub. No.: US 2005/0287414 A1
(43) Pub. Date: Dec. 29, 2005

(54) Fuel cell, and a method for preparing the same

(76) Inventor: Hyung-Gon Noh, Suwon-si (KR)

Correspondence Address: CHRISTIE, PARKER & HALE, LLP, PO BOX 7068, PASADENA, CA, 91109-7068, US

(21) Appl. No.: 11/155,199

(22) Filed: Jun. 16, 2005

(30) Foreign Application Priority Data
Jun. 23, 2004 (KR) 10-2004-0047054

(51) Int. Cl. H01M 8/00

(52) U.S. Cl. 429/36; 429/38

(57) ABSTRACT

Provided are a fuel cell and a preparation method thereof. The fuel cell includes unit cells, each having a membrane electrode assembly, separators placed on either side of the membrane electrode assembly, and spacers at the edge of and between the membrane electrode assembly and the separators, wherein each spacer is adhered by an adhesive to a separator, or to a membrane electrode assembly and a separator. The use of spacers with adhesive in a fuel cell according to the present invention provides excellent airtight sealing of the fuel and oxidant gas of the fuel cell.

### CROSS REFERENCE TO RELATED APPLICATION

This application claims priority to and the benefit of Korean Patent Application No. 10-2004-0047054 on Jun. 23, 2004 filed in the Korean Industrial Property Office, the content of which is incorporated hereinto by reference.

### FIELD OF THE INVENTION

The present invention relates a fuel cell and a method for preparing the same; and, more particularly, to a fuel cell that is sealed to prevent leakage of fuel or oxidant, and a method for preparing the fuel cell.

### BACKGROUND OF THE INVENTION

A fuel cell is an electric power generating system that converts energy of a chemical reaction between oxidant (e.g. oxygen) and fuel (e.g. hydrogen or hydrogen contained in a hydrocarbon-based material such as methanol, ethanol, or natural gas) directly into electric energy.

Fuel cells have wide application including as distributed power sources such as for houses and public buildings, as small power sources such as for electronic devices, and as mobile power sources such as for vehicles.

A fuel cell is prepared by forming unit cells which include one or more membrane electrode assemblies (MEAs) and separators for supplying fuel and oxidant to the membrane electrode assemblies. The separators are often referred to as bipolar plates. In general, a plurality of unit cells are arranged in a stack structure which is called a stack.

In a conventional fuel cell, a gasket with a plane-shaped cross-section is connected to the membrane electrode assembly by compression forces applied to the edge of the membrane electrode assembly. However, a narrow space or gap can be formed between the gasket and the membrane electrode assembly due to a difference in pressure applied to the separators during the connection of the fuel cell. The gap destroys the airtight seal between the membrane electrode assembly and the separators, and thus, fuel and oxidant may leak through the separators. Such leakage degrades the performance of the fuel cell due to a decrease in pressure of the fuel and oxidant as they pass through the separators. Furthermore, the leakage of fuel and oxidant may also cause safety issues.

Korean Patent Laid-Open No. 2003-0094001 discloses a method for preparing a membrane electrode assembly by using an adhesive on catalyst layers of an anode or a cathode and a gas diffusion layer. U.S. Pat. No. 6,165,634 discloses a fuel cell stack with improved airtight sealing by sticking the edge of a membrane electrode assembly on a water transport plate with an elastic adhesive. Japanese Patent Laid-Open No. Hei 9-55214 discloses a method of impregnating a low-viscosity resin and performing calcination at a low temperature to prevent gas of a carbon plate from leaking. However, the sealing methods of the above patent references still have a problem in that fuel and oxidant leak between the membrane electrode assembly and the separators in the stack of a fuel cell because they fail to form a uniform plane when the separators and the membrane electrode assembly are compressed.

### SUMMARY OF THE INVENTION

In one embodiment of the present invention, a fuel cell is provided having a membrane electrode assembly with separators adhering to each other with excellent adhesion.

In another embodiment of the present invention, a method is provided for preparing the fuel cell.

According to one embodiment of the present invention, a fuel cell includes: at least one unit cell which includes a membrane electrode assembly; separators placed on either side of each membrane electrode assembly; and spacers inserted between the membrane electrode assembly and the separators around their edges. The spacers adhere to the separators using an adhesive to prevent leakage.

According to another embodiment of the present invention, a method for preparing such a fuel cell is provided. The method includes the steps of: fabricating a unit cell by adhering a first side of a spacer to one side of a separator using an adhesive.

### BRIEF DESCRIPTION OF THE DRAWINGS

The accompanying drawings, which are incorporated in and constitute a part of the specification, illustrate embodiments of the invention, and together with the description, serve to explain the principles of the invention:

FIG. 1 is an exploded perspective diagram showing a fuel cell in accordance with an embodiment of the present invention; and

FIG. 2 is an exploded cross-sectional diagram illustrating a first embodiment of a unit cell included in the fuel cell.

FIG. 3 is an exploded cross-sectional diagram illustrating a second embodiment of a unit cell included in the fuel cell.

### DETAILED DESCRIPTION

In the following detailed description, certain embodiments of the invention have been shown and described by way of illustration. As will be realized, the invention is capable of modification in various respects, all without departing from the invention. Accordingly, the drawings and description are to be regarded as illustrative in nature, and not restrictive.

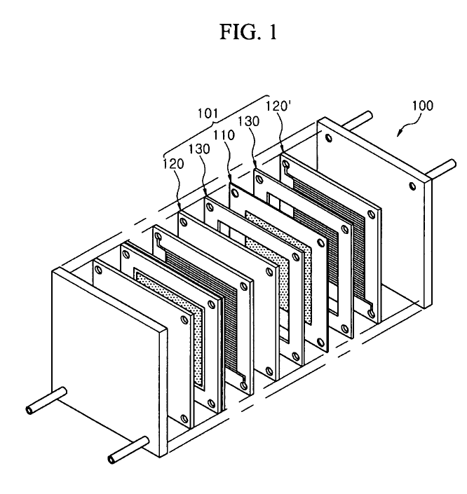

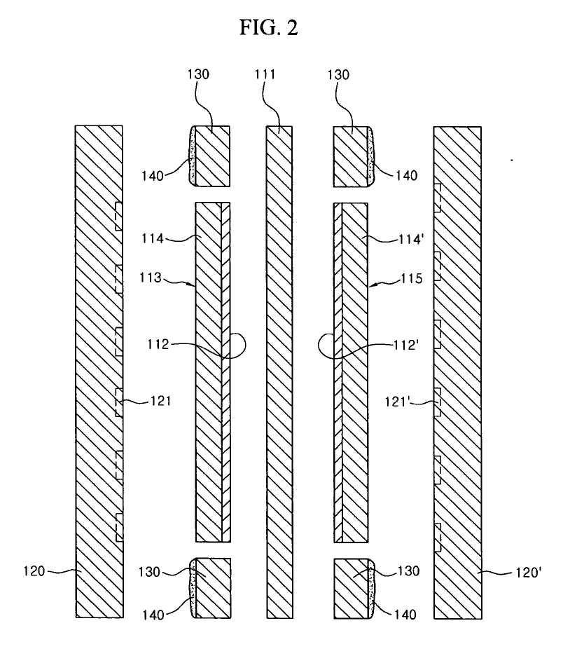

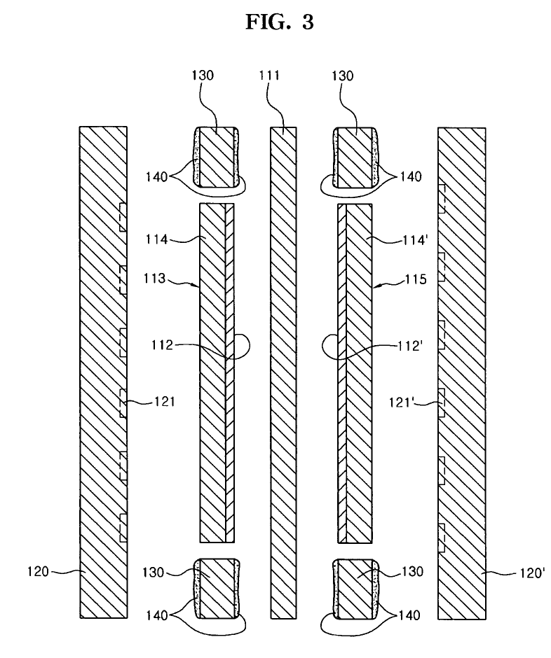

FIG. 1 is an exploded perspective diagram showing a fuel cell in accordance with an embodiment of the present invention, FIG. 2 is an exploded cross-sectional diagram illustrating a first embodiment of a unit cell included in the fuel cell, and FIG. 3 is an exploded cross-sectional diagram illustrating a second embodiment of a unit cell included in the fuel cell.

Referring to the drawings, the fuel cell 100 of the present invention comprises one or more unit cells 101 that generate electric energy by inducing oxidation/reduction reactions between an oxidant such as oxygen and a fuel such as hydrogen, methanol, ethanol, or natural gas. The unit cells 101 are arranged as a stack with the number of unit cells in the stack determined by the required output voltage.

Each unit cell 101 comprises a membrane electrode assembly (MEA) 110, separators 120 and 120′, which are also referred to as bipolar plates, and frame-shaped spacers 130. The MEA oxidizes/reduces fuel and oxidant. The separators 120 and 120′ are placed close to both sides of the MEA 110 and supply fuel and oxidant to the MEA 110. The spacers 130 are inserted between the MEA 110 and the separators 120 and 120′, and adhere to the outer edges of the separators 120 and 120′ or to the outer edges of the MEA 110 and the separators 120 and 120′ with an adhesive 140.

The spacers 130 form a space between the MEA 110 and the separators 120 and 120′ on both sides of the MEA 110. They maintain the dimensions of an electrode while maintaining airtight sealing. They are compressed by the two separators 120 and 120′ when the fuel cell is assembled and prevent fuel and oxidant that are supplied to the MEA 110 through the separators 120 and 120′ from leaking or being mixed with each other.

According to the second embodiment, the spacers 130 can be adhered directly to an outer edge of the polymer electrolyte membrane 111 portion of the MEA 110.

The MEA 110 inserted between the separators 120 and 120′ includes a polymer electrolyte membrane 111 for a fuel cell, an anode 113 formed on one side of the polymer electrolyte membrane 111, and a cathode 115 formed on the other side of the polymer electrolyte membrane 111. For this embodiment, the anode 113 and cathode 115 are slightly smaller than the polymer electrolyte membrane such that the corresponding frame-shaped spacers 130 encircle the anode 113 and cathode 115 and are adhered directly to the polymer electrolyte membrane 111 rather than to the anode 113 or the cathode 115.

The polymer electrolyte membrane 111 has proton conductivity such that protons generated in the catalyst layer of the anode transfer to the catalyst layer of the cathode.

Suitable materials for the polymer electrolyte membrane 111 include fluorine-based polymers, benzimidazole-based polymers, ketone-based polymers, ester-based polymers, amide-based polymers, imide-based polymers, and combinations thereof. Preferred materials include poly(perfluorosulfonic acid), poly(perfluorocarboxylic acid), copolymers of tetrafluoroethylene and fluorovinylether including a sulfonic acid group, defluoridated polyetherketone sulfides, aryl ketones, poly(2,2′-(m-phenylene)-5,5′-bibenzimidazole), poly(2,5-benzimidazole), and combinations thereof. However, the material is not limited thereto.

The anode 113 includes a catalyst layer 112 for receiving fuel through the separator 120 and converting the fuel into electrons and hydrogen ions through an oxidation reaction, and a gas diffusion layer (GDL) 114 for transferring fuel gas smoothly.

The cathode 115 includes a catalyst layer 112′ for receiving oxidant through the separator 120′ and generating water through a reduction reaction between the hydrogen ions supplied through the electrolyte membrane and oxidant, and a gas diffusion layer 114′ for transferring oxidant gas smoothly.

Suitable catalysts for the catalyst layers 112 and 112′ of the anode 113 and the cathode 115 include platinum, ruthenium, platinum-ruthenium alloys, platinum-cobalt alloys, osmium, platinum-osmium alloys, and combinations thereof.

The gas diffusion layers 114 and 114′ of the anode 113 and the cathode 115 may be made of carbon paper or carbon cloth. The MEA 110 can further include an optional microporous layer (not shown) between each of the catalyst layers 112 and 112′ and the gas diffusion layers 114 and 114′ of the anode 113 and the cathode 115. The microporous layer is formed of a conductive material with micrometer-sized pores. Preferably, the microporous layer includes one or more conductive carbon materials selected from the group consisting of graphite, carbon nanotubes (CNT), fullerene (C60), activated carbon, and carbon nanohorns.

The separators 120 and 120′ included in the fuel cell of the present invention function as conductors that connect the anode 113 and the cathode 115 of the MEA 110 serially. In addition, the separators 120 and 120′ provide a path for producing the fuel and oxidant required for the oxidation/reduction reaction of the MEA 110 to the anode 113 and the cathode 115. For this function, the separators 120 and 120′ have flow channels 121 and 121′ for supplying gas needed for the oxidation/reduction reaction that occurs on the surface of the MEA 110.

Each spacer 130 is extends around the edges of the MEA 110 and an adjacent separator 120 or 120′ for maintaining airtight sealing between the MEA 110 and the separators 120 and 120′. The spacers 130 adhere to the MEA 110 and the separators 120 and 120′ with an adhesive 140. Thus, the fuel cell of the present invention has excellent airtight sealing and maintains a space between the MEA 110 and the separators 120 and 120′ by using the spacers 130 inserted thereto. Since the spacers are adhered to the MEA 110 and the separators 120 and 120′ with an adhesive, the manufacturing of a fuel cell is simplified.

Suitable adhesives for adhering the spacers include acrylate-based adhesives such as 2-cyanoacrylate and acrylate monomer composites with 2-cyanoacrylate being a preferred adhesive. Since such acrylate-based adhesives are instant adhesives, their use can shorten the time taken for preparing a fuel cell. Also, since such adhesives can be polymerized very well in moisture, they may be applied in ambient air.

According to one embodiment of the invention, a fuel cell of the present invention is prepared by stacking up one or more unit cells. The method for preparing such a fuel cell includes fabricating unit cells by adhering one side of a spacer to one side of a separator, or both sides of a spacer to one side of a membrane electrode assembly and one side of a separator using an acrylate-based adhesive.

When the unit cells are fabricated, there is no specific restriction in the order by which the adhesives are applied to the various materials. It is possible to put the MEA and the spacers together first and then adhere the separators thereon, and it is also possible to put the spacers and the separators together first and then adhere the spacers on the MEA.

As described above, according to one embodiment of the invention, it is desirable that the anode and cathode of the MEA not overlap with the spacers such that the spacers are adhered to an outer edge of the polymer electrolyte membrane portion of the MEA.

For the polymer electrolyte membrane, any proton conductive polymer can be used. Suitable examples include fluorine-based polymers, benzimidazole-based polymers, ketone-based polymers, ester-based polymers, amide-based polymers, imide-based polymers, and combinations thereof. Preferred proton conductive polymers include poly(perfluorosulfonic acid), poly(perfluorocarboxylic acid), copolymers of tetrafluoroethylene and fluorovinylether including a sulfonic acid group, defluoridated polyetherketone sulfides, aryl ketones, poly(2,2′-(m-phenylene)-5,5′-bibenzimidazole), poly(2,5-benzimidazole), and combinations thereof. However, the material is not limited thereto.

Also, the anode and cathode may each include a catalyst layer and a gas diffusion layer to receive fuel or oxidant gas through the separators, respectively.

Suitable catalyst materials for the catalyst layers of the anode and the cathode include platinum, ruthenium, platinum-ruthenium alloys, platinum-cobalt alloys, osmium, and platinum-osmium alloys.

Suitable materials for gas diffusion layers of the anode and the cathode include carbon paper and carbon cloth. If necessary, the MEA can further include microporous layers (MPLs) between the catalyst layers and the gas diffusion layers of the anode and the cathode. Each microporous layer may be formed of a conductive material with micrometer-sized pores. Suitable materials for the microporous layer include conductive carbon materials such as graphite, carbon nanotubes, fullerene (C60), activated carbon, carbon nanohorns and combinations thereof.

After the spacers and the MEA are put together, the spacers and the separators are adhered to one another with an adhesive and the separators are stacked to contact both sides of the MEA, and more preferably the anode and the cathode, to thereby fabricate unit cells. Either one unit cell can form the fuel cell, or a plurality of unit cells can be stacked upon one another to form the fuel cell. The number of unit cells stacked against one another determine the desired output voltage. It should be noted that in a stack arrangement such as is shown in the embodiment of the invention of FIG. 1, common separators 120 are shared between adjacent unit cells 101.

Suitable adhesives used for preparing the fuel cell are acrylate-based adhesives such as 2-cyanoacrylate, acrylate monomer composites, or combinations thereof. A preferred adhesive is 2-cyanoacrylate.

The following examples further illustrate the present invention in detail, but they are not to be construed to limit the scope thereof.

### EXAMPLE 1

A membrane electrode assembly (MEA) was prepared by forming a cathode layer and an anode layer, each including a platinum catalyst, on two pieces of carbon cloth, and placing the cathode layer and the anode layer to contact both sides of a perfluorosulfonic acid membrane (Nafion® produced by the DuPont Company.)

Subsequently, 2-cyanoacrylate was applied to one side of each of two pre-prepared spacers which were adhered to both sides of an electrolyte membrane on the outer edge of the above-prepared MEA. The other side of the spacers was coated with 2-cyanoacrylate and separators with flow channels formed thereon were placed on both sides of the MEA with the spacers to thereby fabricate unit cells. Then, a fuel cell was prepared by stacking up the unit cells one on another.

### COMPARATIVE EXAMPLE 1

A fuel cell was prepared in the same method as Example 1, except that no adhesive was used for the spacers.

The fuel cells prepared in accordance with Example 1 and Comparative Example 1 were injected with 100 ml hydrogen and maintained under a vacuum for 24 hours. Hydrogen leakage was collected and measured and the results are presented in the following Table 1.

TABLE 1

| | Volume of collected hydrogen (ml) |
|---|---|
| Example 1 | 0.5 |
| Comparative Example 1 | 4 |

It can be seen from Table 1 that the fuel cell prepared in accordance with Example 1 has eight times the airtight sealing as the fuel cell prepared in accordance with Comparative Example 1.

As a consequence, the fuel cell of the present invention is resistant to leakage of fuel and oxidant gas due to the excellent adhesion between the MEA and the separators in the unit cells.

The foregoing is considered illustrative only of the principles of the invention. Further, since numerous modifications and changes will readily occur to those skilled in the art, it is not desired to limit the invention to the exact construction and operation shown and described. Accordingly, all suitable modifications and equivalents that may be resorted to still fall within the scope of the invention and the appended claims.

1. A fuel cell, comprising at least one unit cell comprising:
a membrane electrode assembly;
at least one separator;
a spacer between the membrane electrode assembly and the at least one separator; and
a first layer of adhesive between the spacer and the separator.

2. The fuel cell of claim 1, wherein the spacer is a frame-shaped spacer, and the first layer of adhesive adhere the spacer to edge of the separator.

3. The fuel cell of claim 1, wherein the membrane electrode assembly comprises a polymer electrolyte membrane; an anode formed on a first side of the polymer electrolyte membrane; and a cathode formed on a second side of the polymer electrolyte membrane.

4. The fuel cell of claim 3, wherein the polymer electrolyte membrane comprises a material selected from the group consisting of fluorine-based polymers, benzimidazole-based polymers, ketone-based polymers, ester-based polymers, amide-based polymers, imide-based polymers, and combinations thereof.

5. The fuel cell of claim 4, wherein the polymer electrolyte membrane comprises a material selected from the group consisting of poly(perfluorosulfonic acid), poly(perfluorocarboxylic acid), copolymers of tetrafluoroethylene and fluorovinylether including a sulfonic acid group, defluoridated polyetherketone sulfides, aryl ketones, poly(2,2′-(m-phenylene)-5,5′-bibenzimidazole), poly(2,5-benzimidazole), and combinations thereof.

6. The fuel cell of claim 3, wherein each of the anode and the cathode further comprises a catalyst layer and a gas diffusion layer.

7. The fuel cell of claim 6, wherein each catalyst layer comprises a material selected from the group consisting of platinum, ruthenium, platinum-ruthenium alloys, platinum-cobalt alloys, osmium, platinum-osmium alloys, and combinations thereof.

8. The fuel cell of claim 6, wherein each gas diffusion layer is carbon paper or carbon cloth.

9. The fuel cell of claim 6, wherein the membrane electrode assembly further comprises a microporous layer.

10. The fuel cell of claim 9, wherein the microporous layer comprises at least one conductive carbon material selected from the group consisting of graphite, carbon nanotubes (CNT), fullerene (C60), activated carbon, and carbon nanohorns.

11. The fuel cell of claim 1, wherein the adhesive layer comprises an acrylate-based adhesive.

12. The fuel cell of claim 11, wherein the acrylate-based adhesive is selected from the group consisting of 2-cyanoacrylate, acrylate monomer composites, and combinations thereof.

13. The fuel cell of claim 1, wherein the unit cell further comprises a second layer of adhesive between the spacer and the membrane electrode assembly.

14. The fuel cell of claim 13, wherein the spacer is a frame-shaped spacer, and the first and second layers of adhesive adhere the spacer to edges of the membrane electrode assembly and the separator.

15. The fuel cell of claim 13, wherein each of the adhesive layers comprises an acrylate-based adhesive.

16. A method for preparing a unit cell of a fuel cell, comprising the steps of:
providing a membrane electrode assembly, at least one spacer, and at least one separator; and
adhering a first side of the spacer to one side of the separator with a first adhesive.

17. The method of claim 16, wherein the membrane electrode assembly comprises
a polymer electrolyte membrane;
an anode formed on a first side of the polymer electrolyte membrane; and
a cathode formed on a second side of the polymer electrolyte membrane.

18. The method of claim 16, wherein the spacer is a frame-shaped spacer that is adhered to edge of the separator.

19. The method of claim 17, wherein the polymer electrolyte membrane comprises a material selected from the group consisting of fluorine-based polymers, benzimidazole-based polymers, ketone-based polymers, ester-based polymers, amide-based polymers, imide-based polymers, and combinations thereof.

20. The method of claim 19, wherein the polymer electrolyte membrane comprises a material selected from the group consisting of poly(perfluorosulfonic acid), poly(perfluorocarboxylic acid), copolymers of tetrafluoroethylene and fluorovinylether including a sulfonic acid group, defluoridated polyetherketone sulfides, aryl ketones, poly(2,2′-(m-phenylene)-5,5′-bibenzimidazole), poly(2,5-benzimidazole), and combinations thereof.

21. The method of claim 17, wherein each of the anode and the cathode comprises a catalyst layer and a gas diffusion layer.

22. The method of claim 21, wherein each catalyst layer comprises a material selected from the group consisting of platinum, ruthenium, platinum-ruthenium alloys, platinum-cobalt alloys, osmium, platinum-osmium alloys, and combinations thereof.

23. The method of claim 21, wherein each gas diffusion layer is carbon paper or carbon cloth.

24. The method of claim 21, wherein the membrane electrode assembly further comprises a microporous layer.

25. The method of claim 24, wherein the microporous layer comprises a conductive carbon material selected from the group consisting of graphite, carbon nanotubes (CNT), fullerene (C60), activated carbon, carbon nanohorns, and combinations thereof.

26. The method of claim 16, wherein the first adhesive is an acrylate-based adhesive.

27. The method of claim 26, wherein the acrylate-based adhesive is selected from the group consisting of 2-cyanoacrylate, acrylate monomer composites, and combinations thereof.

28. The method of claim 16, further comprising the step of
adhering a second side of the spacer to one side of the membrane electrode assembly with a second adhesive.

29. The method of claim 28, wherein the spacer is a frame-shaped spacer and the first and second adhesives adhere the spacer to edges of the membrane electrode assembly and the separator.

30. The fuel cell of claim 28, wherein each of the adhesives is an acrylate-based adhesive.
